(19) United States
(12) Patent Application Publication
(10) Pub. No.: US 2008/0273879 A1
(43) Pub. Date: Nov. 6, 2008

(54) Optical Transmission System and Method for Compensating Wavelength Dispersion of Main Signal By Multiplexing Dispersion-Free Control Signal

(76) Inventor: KEIICHI YAMADA, Tokyo (JP)

Correspondence Address: NEC CORPORATION OF AMERICA, 6535 N. STATE HWY 161, IRVING, TX, 75039, US

(21) Appl. No.: 12/047,053

(22) Filed: Mar. 12, 2008

(30) Foreign Application Priority Data
Mar. 25, 2007 (JP) 2007-078032

(51) Int. Cl. H04J 14/02

(52) U.S. Cl. 398/81

(57) ABSTRACT

At the transmit end of an optical transmission link, a main signal and a control signal are multiplexed into an optical multiplex signal and forwarded to the link. The frequency of the control signal is much lower than the frequency of the main signal so that the control signal is not affected by the wavelength dispersion effect of the transmission link. A the receive end of the link, the optical multiplex signal is demultiplexed, recovering the main signal and the control signal. An amount of compensation necessary to compensate for the wavelength dispersion of the recovered main signal is detected and used in combination with the dispersion-free control signal to compensate for the wavelength dispersion of the optical main signal. The main signal and the control signal may either be frequency division multiplexed or wavelength division multiplexed into the optical multiplex signal.

### RELATED APPLICATION

This application is based upon and claims the benefit of priority from Japanese Patent Application No. 2007-078032, filed on Mar. 25, 2007, the contents of which are incorporated herein by reference.

### BACKGROUND OF THE INVENTION

1. Field of the Invention

The present invention relates to optical transmission systems and more specifically to an optical transmission system and method for compensating for the wavelength dispersion of an optical main that occurs during transmission over a long distance optical transmission link.

2. Description of the Related Art

The long-distance optical transmission link comprises an optical transmitter provided at the transmit end of an optical transmission link and an optical receiver at the receive end of the link. The optical transmitter receives an optical signal from a client transmitter and converts it to an optical signal of a predetermined wavelength and a predetermined power level and transmits the optical signal to the optical receiver through the transmission link. On receiving the optical signal, the optical receiver converts it to an electrical signal for a dispersion compensation process and reconverts it to an optical signal of a wavelength and power that meet specified standards and transmits the optical signal to a client receiver. When the optical signal propagating over the transmission link has a bit rate higher than 40 Giga bits/second per channel, in particular, a dispersion compensation filter (fiber) is provided in the transmission link to suppress a fixed amount of wavelength dispersion on the propagating optical signal and the optical receiver is provided with a variable dispersion compensation circuit to suppress the wavelength dispersion effect by an amount that varies over time. The optical receiver is provided with a variable dispersion compensation circuit and an associated control circuit to suppress the variable amount of the wavelength dispersion of the link.

Japanese Patent Publication 2004-228925 discloses a prior art technique of the present invention. According to this related art, an optical sinusoidal supervisory signal is wavelength-multiplexed with the optical main signal and transmitted. During transmission the optical supervisory signal is influenced by the wavelength dispersion effect of the link in the same way as the optical main signal. At the receive end of the link, the optical supervisory signal is demultiplexed from the optical main signal, converted to an electrical signal and compared with a reference sinusoidal signal to detect the phase difference. Based on the detected phase difference, the variable dispersion compensation circuit is controlled to compensate for the variable component of the wavelength dispersion of the optical main signal.

However, the related art optical receiver depends solely on the internal information to control its dispersion compensation circuit. As a result, when an out-of-frame sync occurs the transmission system cannot determine whether it is caused by inadequate dispersion compensation or instability of the transmission power of the optical signal. An optical transmission system is also known in the art as one using the overhead of the optical main signal for purposes of both remote control and supervision. However, this transmission system cannot perform its remote control and supervisory functions when an out-of-frame sync occurs in the received signal.

### SUMMARY

It is therefore an exemplary object of the present invention to provide wavelength dispersion compensation of a transmitted optical main signal by multiplexing it with a remote control and monitoring (RCM) signal whose frequency is so low that the latter is free from the wavelength dispersion effect of an optical transmission medium.

According to an exemplary aspect of the present invention, there is provided an optical transmission system comprising multiplexer means for producing an optical multiplex signal comprising a main signal and a control signal whose frequency is lower than a frequency of the main signal so that the control signal is not affected by wavelength dispersion during transmission and transmitting the optical multiplex signal to an transmit end of an optical transmission medium, demultiplexer means for receiving the optical multiplex signal at a receive end of the transmission medium and recovering therefrom the main signal and the control signal, variable dispersion compensator means for compensating for wavelength dispersion of the recovered main signal, detector means for detecting, from an output signal of the variable dispersion compensator means, an amount of compensation necessary to compensate for the wavelength dispersion of the recovered main signal, and control means for controlling the variable dispersion compensator means in accordance with the amount of compensation and the recovered control signal.

According to another exemplary aspect, the present invention provides an optical transmission method comprising the steps of (a) producing an optical multiplex signal comprising a main signal and a control signal and transmitting the optical multiplex signal to an transmit end of an optical transmission medium, the control signal whose frequency is lower than a frequency of the main signal so that the control signal is not affected by wavelength dispersion during transmission over the medium, (b) receiving the optical multiplex signal at a receive end of the transmission medium and recovering therefrom the main signal and the control signal, (c) detecting an amount of compensation necessary to compensate for wavelength dispersion of the recovered main signal, and (d) compensating for the wavelength dispersion of the recovered main signal in accordance with the amount of compensation and the recovered control signal.

### BRIEF DESCRIPTION OF THE DRAWINGS

The present invention will be described in detail with reference to the following drawings, in which:

FIG. 1 is a block diagram of an optical transmission system of the present invention, in which the main and control signals are frequency division multiplexed into an optical multiplex signal for transmission;

FIG. 2 is an illustration of signal components of an amplitude modulated frequency division multiplex signal that appear in the system of FIG. 1; and

FIG. 3 is a block diagram of a modified optical transmission system of the present invention, in which the main and control signals are wavelength division multiplexed into an optical multiplex signal for transmission.

### EXEMPLARY EMBODIMENT

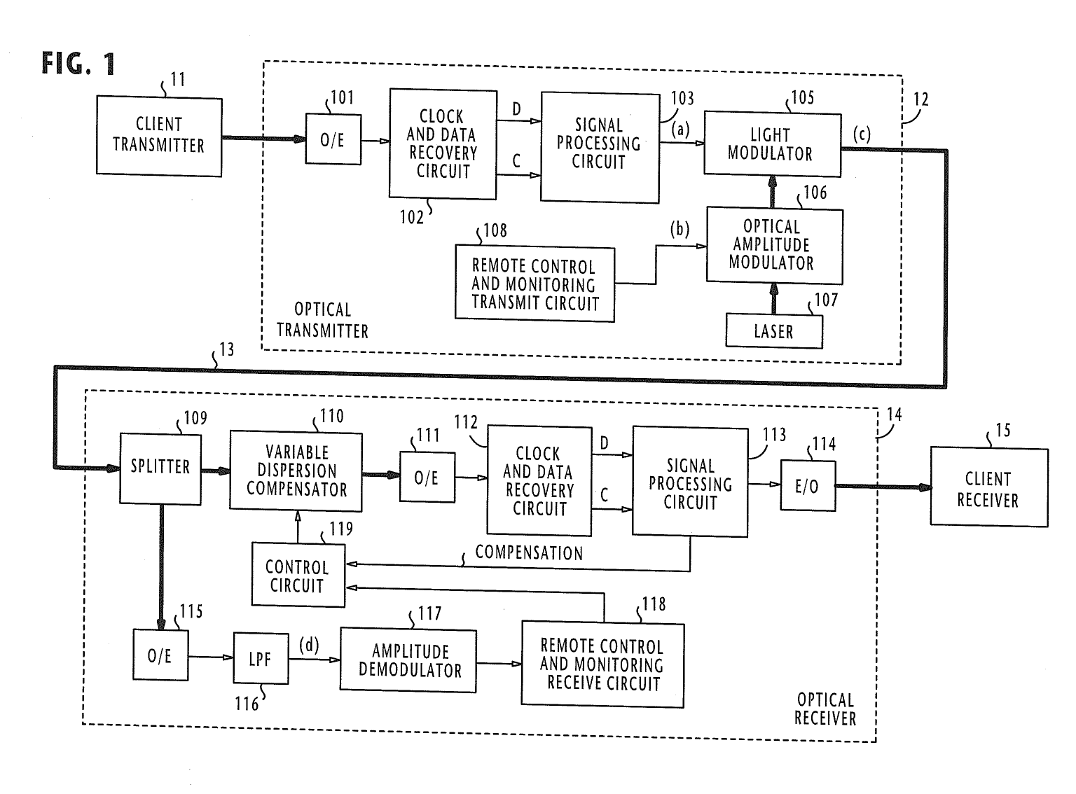

Referring now to FIG. 1, there is shown a long-distance optical transmission system according to an exemplary embodiment of the present invention. The optical transmission system comprises an optical transmitter 12 that receives an optical signal from a client transmitter 11 on the upstream side of the transmission system and transmits its output to an optical transmission link 13, and an optical receiver 14 that receives the output of optical transmitter 12 via the optical transmission link 13 and transmits an optical signal to a client receiver 15 on the downstream side of the system as a replica of the original optical signal of client transmitter 11.

Optical transmitter 12 includes an opto-electrical converter 101 that converts the optical signal from the client transmitter 11 to an electrical signal and a clock-and-data recovery circuit 102 that recovers the original data and clock signal and feeds a signal processing circuit 103.

Signal processing circuit 103 performs frame-sync and supervision and forward error correction on the data output of data and clock recovery circuit 102 and outputs the processed data to a light modulator 105, which forms part of a frequency division multiplexer. On the other hand, a laser beam is injected from a laser 107 into an optical amplitude modulator 106, where the laser beam is amplitude-modulated with the output of a remote control and monitoring (RCM) transmit circuit 108 to produce an optical RCM signal. The optical RCM signal is amplitude-modulated by the light modulator 105 onto the output of signal processing circuit 103, producing an optical frequency-division multiplex signal comprising a main signal and a control signal. The optical frequency-division multiplex signal is delivered to the optical transmission link 13 for propagation to the optical receiver 14.

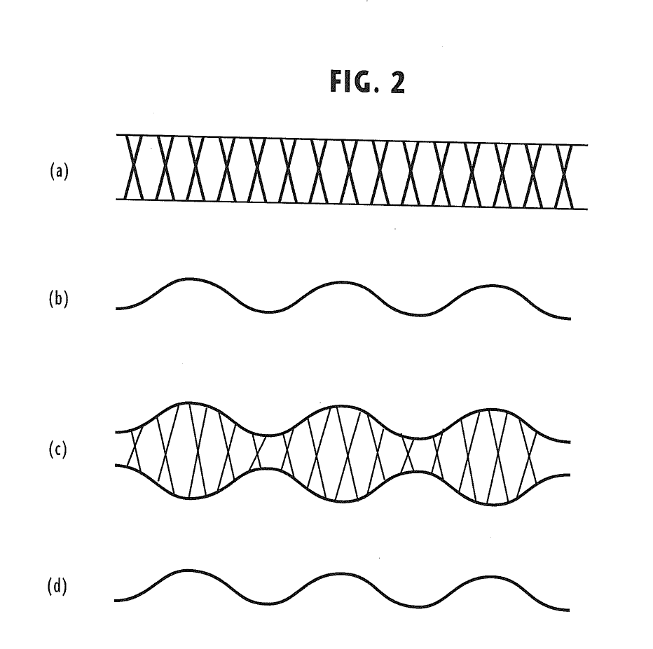

Note that the bit rate (frequency) of the RCM signal is much lower than the bit rate (frequency) of the optical main signal. Therefore, the waveform of the transmitted optical signal takes the form of a superposition of the main signal and the RCM signal. If the main signal and the control signal are as shown in parts (a) and (b) of FIG. 2, respectively, the optical frequency-division multiplex signal will appear as shown in part (c) of FIG. 2 at the output of light modulator 105.

Because of the low bit rate, the transmitted RCM signal is not affected by the wavelength dispersion effect of the optical transmission medium 13. Hence the information representing the status (intensity) of an optical transmit signal, which is detected by the optical amplitude modulator 106, can be retained in the RCM transmit signal and retrieved at the optical receiver 14.

The optical signal transmitted from the optical transmitter 12 propagates the transmission link 13 and enters an optical splitter 109 on arriving the optical receiver 14, dividing itself into two optical components. One optical component is supplied to a variable dispersion compensator 110 that performs wavelength dispersion compensation on the input signal depending on the output of a control circuit 119. The optical output of variable dispersion compensator 110 is converted to an electrical signal and fed to a clock and data recovery circuit 112, where the data signal and the clock signal are recovered and respectively supplied to a signal processing circuit 113. Using the recovered clock signal, the signal processing circuit 113 performs frame synchronization and error detection and correction on the recovered data signal. The processed data signal is then converted to an optical signal by an electro-optical converter 114 and transmitted to the client receiver 15. Further, the signal processing circuit 113 uses the recovered data signal to detect its component that has been influenced by the wavelength dispersion effect of the transmission medium and produces a compensation signal that can compensate for the affected component of the received optical signal. This compensation signal is applied to the control circuit 119.

The other optical component of the splitter 109 is converted to an electrical signal by an opto-electrical converter 115 and low-pass filtered by a low-pass filter 116 to detect the low-frequency component of the received optical signal as shown in part (d) of FIG. 2 that corresponds to the RCM transmit signal that is amplitude-modulated by the optical amplitude modulator 106. The output of low-pass filter 116 is then amplitude-demodulated by an amplitude demodulator 117.

Since the wavelength dispersion effect of transmission link 13 has left no trace of influence on the received RCM signal, the output of amplitude demodulator 117 represents a replica of the original waveform of the transmitted RCM signal. The recovered RCM signal is supplied to a remote control and monitoring (RCM) receive circuit 118 that recovers a clock signal and detects RCM control data, which is then fed into the control circuit 119. According to both of the RCM control data and the compensation control signal from signal processing circuit 113, the control circuit 119 controls the variable dispersion compensator 110.

Therefore, the optical receiver 14 has the ability to acquire the transmitted RCM signal without dependency on the quality of the optical main signal from the wavelength dispersion effect of the transmission medium. The detected RCM signal represents the status (intensity) of the transmitted optical power. This allows the variable dispersion compensator 110 to function properly even though an out-of-frame condition occurs in the optical main signal.

Additionally, because the RCM transmit circuit 108 can communicate with the RCM receive circuit 118 without dependency on the frame sync condition of the optical main signal, remote control and monitoring of the variable dispersion compensator 110 can also be ensured even though an out-of-frame condition occurs in the optical main signal.

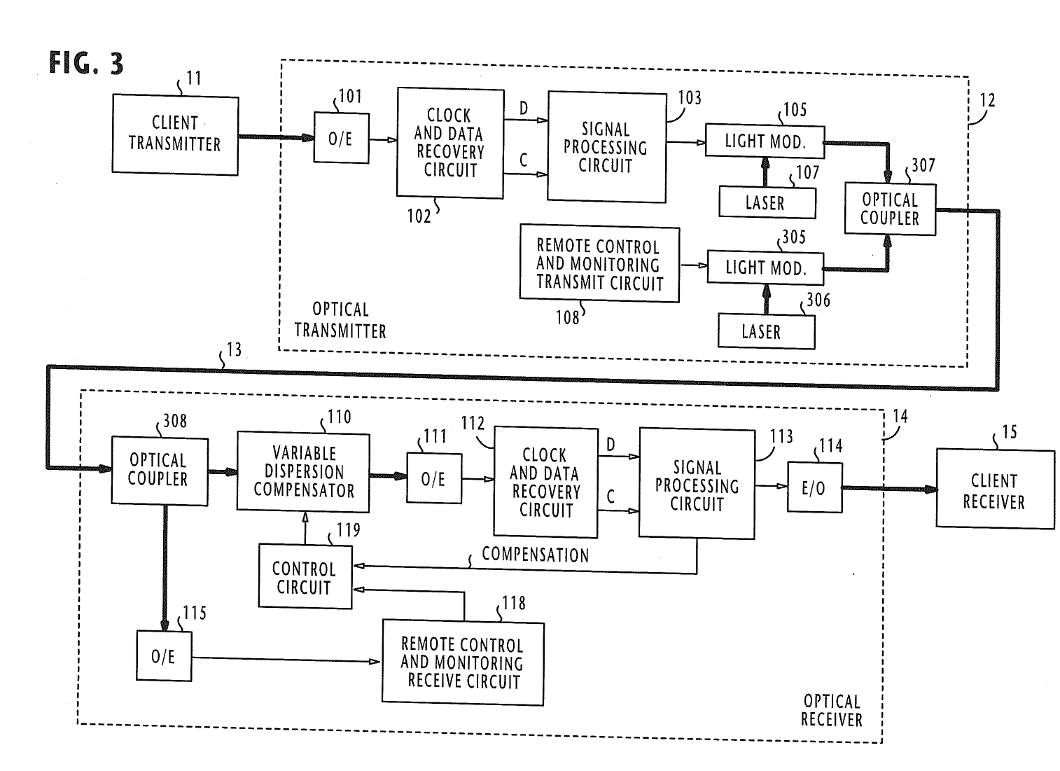

A modified embodiment of the present invention is shown in FIG. 3. In this modification, the main signal and the control signals are wavelength division multiplexed into an optical multiplex signal for transmission.

In the optical transmitter 12 of FIG. 3, the output of signal processing circuit 103 is modulated by the light modulator 105 onto a laser beam of a first wavelength supplied from the laser 107. On the other hand, the output of RCM transmit circuit 108 is modulated by a light modulator 305 onto a laser beam of a second wavelength different from the first wavelength supplied from a laser 306. The outputs of light modulators 105 and 305 are wavelength division multiplexed by an optical coupler 307 and forwarded onto the optical transmission link 307.

In the optical receiver 14 of FIG. 3, the transmitted WDM optical signal is wavelength division demultiplexed by an optical coupler 308 into the optical signals of the first and second wavelengths. The optical signal of the first wavelength is fed to variable dispersion compensator 110 and the optical signal of the second wavelength is converted to an electrical signal by opto-electrical converter 115 to produce a replica of the original waveform of the output of RCM transmit circuit 108. The output of the O/E converter 115 is directly coupled to the RCM receive circuit 118, instead of being coupled through the low-pass filter 116 and amplitude demodulator 117 of FIG. 1.

What is claimed is:

1. An optical transmission system comprising:
multiplexer means for producing an optical multiplex signal comprising a main signal and a control signal and transmitting the optical multiplex signal to an transmit end of an optical transmission medium, said control signal whose frequency is lower than a frequency of said main signal so that said control signal is not affected by wavelength dispersion during transmission over said medium;
demultiplexer means for receiving said optical multiplex signal at a receive end of said transmission medium and recovering therefrom said main signal and said control signal;
variable dispersion compensator means for compensating for wavelength dispersion of the recovered main signal;
detector means for detecting, from an output signal of said variable dispersion compensator means, an amount of compensation necessary to compensate for said wavelength dispersion of said recovered main signal; and
control means for controlling said variable dispersion compensator means in accordance with said amount of compensation and said recovered control signal.

2. The optical transmission system of claim 1, wherein said multiplexer means comprises frequency division multiplexer means and said demultiplexer means comprises frequency division demultiplexer means.

3. The optical transmission system of claim 2, wherein said frequency division multiplexer means comprises an optical amplitude modulator that amplitude modulates said control signal onto a laser beam and a light modulator for modulating said main signal onto said amplitude-modulated laser beam, and wherein said frequency division demultiplexer means comprises an opto-electrical converter that converts said optical multiplex signal to an electrical multiplex signal and an amplitude demodulator that amplitude demodulates said electrical multiplex signal into said control signal.

4. The optical transmission system of claim 3, further comprising a low-pass filter for detecting a low frequency signal from the output of said opto-electrical converter.

5. The optical transmission system of claim 1, wherein said multiplexer means comprises wavelength division multiplexer means that wavelength division multiplexes said main signal and said control signal into said optical multiplex signal, and said demultiplexer means comprises wavelength division demultiplexer means that wavelength-division demultiplexes said optical multiplex signal into said main signal and said control signal.

6. The optical transmission system of claim 1, wherein said control signal is a remote control and monitoring signal.

7. The optical transmission system of claim 1, wherein said variable dispersion compensator means comprises an optical variable wavelength dispersion compensator that performs wavelength dispersion compensation on an optical version of the recovered main signal according to an output signal from said control means.

8. An optical transmission method comprising the steps of:
a) producing an optical multiplex signal comprising a main signal and a control signal and transmitting the optical multiplex signal to an transmit end of an optical transmission medium, said control signal whose frequency is lower than a frequency of said main signal so that said control signal is not affected by wavelength dispersion during transmission over said medium;
b) receiving said optical multiplex signal at a receive end of said transmission medium and recovering therefrom said main signal and said control signal;
c) detecting an amount of compensation necessary to compensate for wavelength dispersion of said recovered main signal; and
d) compensating for the wavelength dispersion of the recovered main signal in accordance with said amount of compensation and said recovered control signal.

9. The optical transmission method of claim 8, wherein step (a) comprises frequency division multiplexing said main signal and said control signal into said optical multiplex signal and step (b) comprises frequency division demultiplexing the optical multiplex signal into said main signal and said control signal.

10. The optical transmission method of claim 8, wherein step (a) comprises the steps of:
amplitude-modulating said control signal onto a laser beam; and
modulating said main signal onto said amplitude-modulated laser beam, and wherein step (b) comprises the steps of:
converting said optical multiplex signal to an electrical multiplex signal; and
amplitude demodulating said electrical multiplex signal into said control signal.

11. The optical transmission method of claim 10, wherein step (b) further comprises the step of detecting a low frequency signal from said electrical multiplex signal prior to amplitude demodulating said electrical multiplex signal.

12. The optical transmission method of claim 8, wherein step (a) comprises wavelength division multiplexing said main signal and said control signal into said optical multiplex signal, and step (b) comprises wavelength division demultiplexing said optical multiplex signal into said main signal and said control signal.

13. The optical transmission method of claim 8, wherein said control signal is a remote control and monitoring signal.

14. The optical transmission method of claim 8, wherein step (d) comprises compensating for the wavelength dispersion of an optical version of said recovered main signal in accordance with said amount of compensation and said recovered control signal.
